(19) United States
(12) Patent Application Publication
(10) Pub. No.: US 2026/0103010 A1
(43) Pub. Date: Apr. 16, 2026

(54) LABEL PRESENTER AND INSPECTION SYSTEM AND APPARATUS FOR USE WITH A LABEL PRINTER

(71) Applicant: Nautilus Systems, Inc., Phoenix, AZ (US)

(72) Inventors: Steve Gunnerson, Peoria, AZ (US); Eric Moore, Waddell, AZ (US)

(21) Appl. No.: 19/355,867

(22) Filed: Oct. 10, 2025

Related U.S. Application Data
(60) Provisional application No. 63/705,920, filed on Oct. 10, 2024.

(51) Int. Cl. B41J 3/44; B25J 11/00; B41J 3/407; B41J 11/00; B41J 11/06; B65C 9/26; B65C 9/40; G06T 7/00

(52) U.S. Cl. CPC B41J 3/44; B25J 11/0075; B41J 3/4075; B41J 11/0085; B41J 11/06; B65C 9/26; B65C 9/40; G06T 7/0004; B65C 2009/407; G06T 2207/30144

(57) ABSTRACT

A label printer system and apparatus that enables inspection and removal of a label before applying it to product and a label presenter and inspection system and apparatus that be used with any thermal transfer label printer which enables inspection and removal of a label before applying it to product.

### CROSS-REFERENCE TO RELATED APPLICATIONS

This application claims priority to provisional patent application having Ser. No. 63/705,920, filed Oct. 10, 2024, which is herein incorporated by reference in its entirety.

### FIELD OF INVENTION

The present invention is directed to a system and apparatus for presenting and inspecting labels generated from a label printer prior to removing and applying the labels to products. The label presenter and inspection system and apparatus includes a platform having at least one magnet or fastener, at least one vacuum channel, and at least one air channel all contained within the platform and a removable magnetic or non-magnetic non-stick platen having at least one vacuum hole or channel and at least one label glide air hole contained therein wherein the removable magnetic or non-magnetic non-stick platen is positioned on top of the platform so that the vacuum hole(s) or channel(s) is/are positioned above the vacuum channel(s) in the platform and the label glide air hole(s) is/are positioned above the air channel(s) in the platform. The removable non-stick platen is secured to the top of the platform by either a magnet contained within the platform or a fastener contained within, or attached to, the platform. If the platform includes a magnet, the removable non-stick platen is magnetic. If the platform includes a fastener, the removable non-stick platen is non-magnetic.

The present invention is also directed to a system and apparatus for presenting, inspecting, and removing labels generated from a label printer prior to applying the labels to products. This system and apparatus includes the same platform and removable magnetic or non-magnetic non-stick platen described above in addition to a camera for visual inspection of the label and a robotic arm with an end effector for removing the label from the removable magnetic or non-magnetic non-stick platen.

### BACKGROUND OF THE INVENTION

Currently existing label printing systems automate the printing of labels and the application of those labels to products. However, the currently existing label printing and application systems do not enable inspection of the labels prior to applying them to products. Therefore, product labels are inspected after application to products. Bad or inferior labels applied to products can result in costly reworking to apply correct labels or even scrapping product that has been labeled with incorrect labels thereby significantly increasing costs.

Accordingly, there is a need for a system and apparatus for a label printer and inspector with automated label inspection options. Such a system like that of the present invention provides for printing labels and dispensing them to a flat non-stick platen where the label can be inspected by a vision system that can perform optical character recognition verification and/or bar code verification and even barcode grading. The flat non-stick surface of the platen permits easy removal of the label by automation (such as robots or other pick/place devices) after inspection. Accordingly, a user of the system and apparatus can ensure that a printed label is good or accurate before the label is applied to product. With the system and apparatus of the present invention, acceptable labels can be applied to product while unacceptable labels can be placed in a rejection collection area.

### SUMMARY OF THE INVENTION

The present invention is directed to a system and apparatus for presenting and inspecting labels generated from a label printer prior to removing and applying the labels to products. The system and apparatus may include a flat non-stick platen for retaining the label while printing and inspecting the label, a vision system such as a camera system that can inspect the printed label for accuracy while on the flat non-stick platen, and an automated system such as a robotic arm with an end effector for removing the printed label from the flat non-stick platen that can then apply the label to product or place the label in a rejection collection area.

In one exemplary embodiment, the label printer system and apparatus of the present invention includes a label printer, a platform connected to the label printer having at least one magnet or fastener, at least one vacuum channel, and at least one air channel all contained within the platform, and a removable magnetic or non-magnetic non-stick platen having at least one vacuum hole or channel and at least one label glide air hole contained therein wherein the removable magnetic or non-magnetic non-stick platen is positioned on top of the platform such that said at least one vacuum hole or channel is positioned above the at least one vacuum channel in the platform and said at least one label glide air hole is positioned above the at least one air channel in the platform.

The label printer system and apparatus may further include a pneumatic and/or electronic mechanism for moving the platform to another position for inspection and/or removal of a printed adhesive label positioned on top of the removable magnetic or non-magnetic non-stick platen. It may also include a vision system that can inspect the printed adhesive label for accuracy while on the removable magnetic or non-magnetic non-stick platen. The label printer system and apparatus may further include an automated system for removing the printed adhesive label from the removable magnetic or non-magnetic non-stick platen that can then apply the label to a product or place the label in a rejection collection area. The automated system may be a robotic arm with an end effector that contacts the label.

In another exemplary embodiment, the present invention is directed to label presenter and inspection system that can be used with any existing prior art label printer which enables inspection and removal of a label from the system prior to applying the label to any product. The label presenter and inspection system includes a platform having at least one magnet or fastener, at least one vacuum channel, and at least one air channel all contained within the platform, and a removable magnetic or non-magnetic non-stick platen having at least one vacuum hole or channel and at least one label glide air hole contained therein wherein the removable magnetic or non-magnetic non-stick platen is positioned on top of the platform such that said at least one vacuum hole or channel is positioned above the at least one vacuum channel in the platform and said at least one label glide air hole is positioned above the at least one air channel in the platform. The platform may further include at least one indentation or relief area to facilitate removal of the removable magnetic or non-magnetic non-stick platen from the platform and/or at least one locating dowel.

The label presenter and inspection system may further include an air manifold positioned below the at least one air channel and the at least one vacuum channel contained in the platform and a label glide fan positioned beneath the air manifold. The label presenter and inspection system may also include a housing connected to the platform and the air manifold where the housing contains at least one air flow control for controlling air flow provided to the pneumatic shuttle, when used, and a vacuum generator for providing a vacuum to the at least one vacuum channel in the platform. A vacuum sensor may also be contained within the housing for sensing a vacuum provided to the at least one vacuum channel in the platform and the vacuum hole(s) or channel(s) contained in the removable magnetic or non-magnetic non-stick platen. The housing may also include an air inlet for providing air to the air channel(s) contained in the platform for moving the platform and platen forward and backward. The label glide air fan positioned beneath the air manifold provides air flow to the label glide air hole(s) contained in the removable magnetic or non-magnetic non-stick platen so that labels can easily move across the removable non-stick platen.

The label presenter and inspection system may also include a pneumatic or electronic mechanism for moving the platform to another position for inspection and/or removal of a printed adhesive label positioned on top of the removable magnetic or non-magnetic non-stick platen. The system may further include a vision system that can inspect the printed adhesive label for accuracy prior to removing the label from the removable magnetic or non-magnetic non-stick platen and applying it to a product. The label presenter and inspection system may also include an automated system for removing the printed adhesive label from the removable magnetic or non-magnetic non-stick platen that can apply the label to a product or place the label in a rejection collection area.

The present invention is also directed to a method for presenting and inspecting a printed label prior to applying the label to product that includes the steps of i) providing a platform connected to a label printer wherein the platform has at least one magnet or fastener, at least one vacuum channel, and at least one air channel all contained within the platform; ii) providing a removable magnetic or non-magnetic non-stick platen having at least one vacuum hole or channel and at least one label glide air hole contained therein wherein the removable magnetic or non-magnetic non-stick platen is positioned on top of the platform such that said at least one vacuum hole or channel is positioned above the at least one vacuum channel in the platform and said at least one label glide air hole is positioned above the at least one air channel in the platform; iii) providing air pressure through the at least one air channel in the platform and the at least one label glide air hole in the platen to float a label across a top surface of the platen while the label is being printed; and iv) applying a vacuum through the at least one vacuum channel in the platform and the at least one vacuum hole or channel in the platen to secure and hold the printed label in place on the top surface of the platen while it is inspected for accuracy.

The method for presenting and inspecting a printed label prior to applying the label to product may also include the steps of moving the platform to another position and inspecting the printed label for accuracy and removing the printed label from the top of the removable magnetic or non-magnetic non-stick platen with a robotic arm and applying it to product if the label is accurate or placing the label in a rejection collection area if the label is not accurate.

Additional exemplary embodiments and features of the system and apparatus of the present invention for a label printer system and apparatus and a label presenter and inspection system and apparatus which enables inspection and removal of the label before applying it to product are further described below.

### BRIEF DESCRIPTION OF THE DRAWINGS

The subject invention will hereinafter be described in conjunction with the appended drawing figures, wherein like numerals denote like elements, and

FIG. 1 is a perspective view of the system and apparatus of the present invention for printing, presenting, and inspecting labels prior to applying the labels to product;

FIG. 2 is an exploded front perspective view of a portion of the system and apparatus of the present invention for printing, presenting, and inspecting labels which shows the system and apparatus for presenting and inspecting printed labels with a removable magnetic non-stick platen shown removed from the platform;

FIG. 3 is a top and side perspective view of a portion of the apparatus of the present invention which shows the system and apparatus for presenting and inspecting printed labels without the housing that covers a portion of the components for presenting and inspecting printed labels shown with the removable magnetic non-stick platen positioned on the platform;

FIG. 4 is a side perspective view of a portion of the apparatus of the present invention which shows the system and apparatus for presenting and inspecting printed labels without the housing that covers a portion of the components for presenting and inspecting printed labels shown with an adhesive label positioned on the removable magnetic non-stick platen;

FIG. 5 is a side perspective view of the portion of the apparatus of the present invention which shows the system and apparatus for presenting and inspecting printed labels shown in FIG. 4 with the housing that covers a portion of the components for presenting and inspecting printed labels shown with an adhesive label positioned on the removable magnetic non-stick platen;

FIG. 6 is a front perspective view of the portion of the apparatus of the present invention which shows the system and apparatus for presenting and inspecting printed labels shown in FIG. 5;

FIG. 7 is a front perspective view of the portion of the apparatus of the present invention which shows the system and apparatus for presenting and inspecting printed labels shown in FIG. 6 without the housing that covers a portion of the components for presenting and inspecting printed labels;

FIG. 8 is a schematic showing two different perspective views of the overall system of the present invention for printing, presenting, inspecting, and removing printed labels where the system is shown in a stage where the printed label is presented and accessible for inspection by a vision system having a camera and where a robotic arm for removing a printed label from the removable magnetic non-stick platen is in an “away” position;

FIG. 9 is a schematic showing two different perspective views of the overall system of the present invention for printing, presenting, inspecting, and removing printed labels where the system is shown in a stage where the robotic arm is moving into position to remove the printed label from the removable magnetic non-stick platen; and

FIG. 10 is a schematic showing two different perspective views of the overall system of the present invention for printing, presenting, inspecting, and removing printed labels where the system is shown in a stage where the end effector of the robotic arm is touching the printed label positioned on the removable magnetic non-stick platen in order to remove the printed label from the platen.

### DETAILED DESCRIPTION

The present invention is directed to a label printer system and apparatus and a label presenter and inspection system and apparatus that be used with any thermal transfer label printer which enables inspection and removal of a label before applying it to product.

### System Components

The system and apparatus of the present invention consists of several major components which may include some or all of:
1) Label Printer—a standard label printer or thermal transfer label printer capable of printing labels for application to products and particularly printing adhesive labels for application to products.
2) Platform—a platform for supporting a removable magnetic or non-magnetic non-stick platen where the platform includes at least one magnet or fastener, at least one vacuum channel, and at least one air channel all contained within the platform. The platform may also include a locating dowel for precisely locating the magnetic or non-magnetic non-stick platen on the platform for consistency and ease of setup or changeover.
3) Removable magnetic or non-magnetic non-stick platen—a removable magnetic or non-magnetic non-stick platen having at least one vacuum hole or channel and at least one label glide air hole contained therein wherein the removable magnetic or non-magnetic non-stick platen is positioned on top of the platform such that the at least one vacuum hole or channel in the platen is positioned above the at least one vacuum channel in the platform and the at least one label glide air hole in the platen is positioned above the at least one air channel in the platform. The platen may include a plurality of vacuum holes and/or a plurality of label glide air holes to ensure that a label can move across, as well as be secured to, the platen.
4) Air manifold—an air manifold positioned below the platform for directing air to the to the at least one air channel in the platform.
5) Label glide fan—a label glide fan positioned beneath the air manifold for enabling a controlled air layer to assist the label in moving across the non-stick platen as the label is printed (similar to an air hockey table effect).
6) Housing—a housing connected to the platform and the air manifold and the label glide fan where the housing contains at least one air flow control for controlling air provided to the pneumatic shuttle, when used, and a vacuum generator for providing a vacuum to the at least one vacuum hole contained in the platform and the at least one vacuum hole or channel contained in the platen. The housing may also include an air inlet for providing air to the vacuum generator and the air flow control which in turn provides air to the pneumatic shuttle, when used.
7) Vacuum sensor—a vacuum sensor contained within the housing for sensing a vacuum provided to the at least one vacuum channel contained in the platform.
8) Pneumatic or electrical mechanism for moving the platform and removable platen to another position for inspection and/or removal of a printed adhesive label positioned on top of the removable magnetic or non-magnetic non-stick platen
9) Vision system—a vision system such as a camera that can inspect the printed adhesive label for accuracy prior to removing it from the removable magnetic or non-magnetic non-stick platen. The vision system may also look at label size and/or shape—e.g., the vision system may be able to measure the label and/or assess the shape of the label to determine if the label meets certain label specifications so that the label can be rejected if it does not meet certain specs.
10) Automated label removing system—an automated system such as a robotic arm with an end effector for removing a printed adhesive label from the removable magnetic or non-magnetic non-stick platen and applying the label to a product if the label is accurate or discarding the label in a rejection collection area if the label is not accurate.

Reference numbers contained in the figures refer to specific features as follows:
10 label printer system and apparatus
12 printer
14 platform
16 removable magnetic non-stick platen
20 label presenter and inspection system and apparatus
24 platform
26 removable magnetic non-stick platen
28 magnets
30 vacuum channel (in platform)
32 air channel (in platform)
34 indentations/relief areas (in platform)
36 locating dowels (in platform)
40 vacuum holes/channels (in platen)
42 label glide air holes (in platen)
44 air manifold
46 label glide fan
50 housing
52 air flow controls (in housing)
54 vacuum generator (in housing)
56 pneumatic or electronic generator for shuttling/moving platform and platen
58 vacuum sensor (in housing)
60 air inlet (in housing)
70 vision system (camera)
72 robot/robotic arm
74 robot/robotic arm end effector

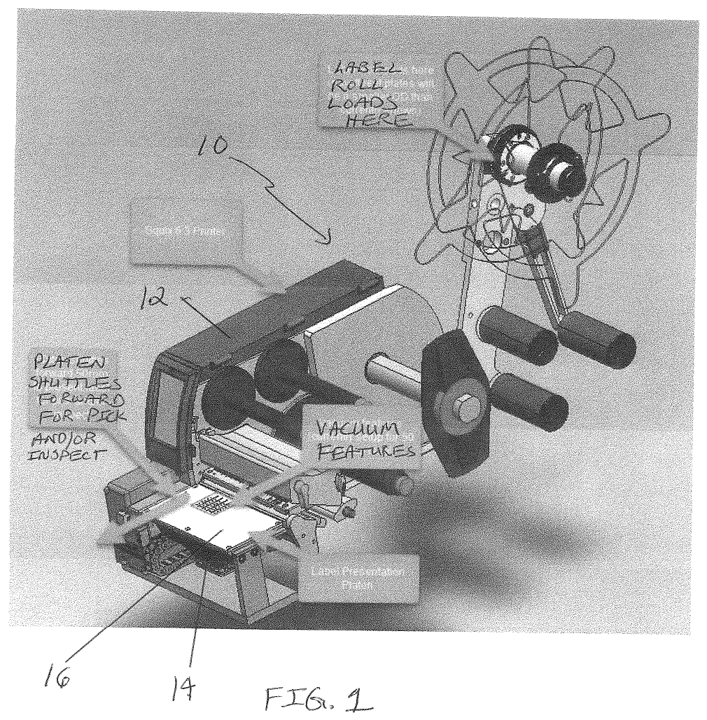

An exemplary embodiment of the system and apparatus of the present invention 10 for printing, presenting, and inspecting labels prior to applying the labels to product is shown in FIG. 1. The system and apparatus 10 includes a label printer 12, a platform 14 connected to the label printer 12 wherein the platform 14 has at least one magnet or fastener, at least one vacuum channel, and at least one air channel all contained within or on the platform 14, and a removable magnetic or non-magnetic non-stick platen 16 having at least one vacuum hole or channel and at least one label glide air hole contained therein where the removable magnetic or non-magnetic non-stick platen 16 is positioned on top of the platform 14 such that the vacuum hole(s) or channel(s) in the platen 16 are positioned above the vacuum channel(s) in the platform 14 and the label air glide hole(s) in the platen 16 are positioned above the air channel(s) in the platform 14.

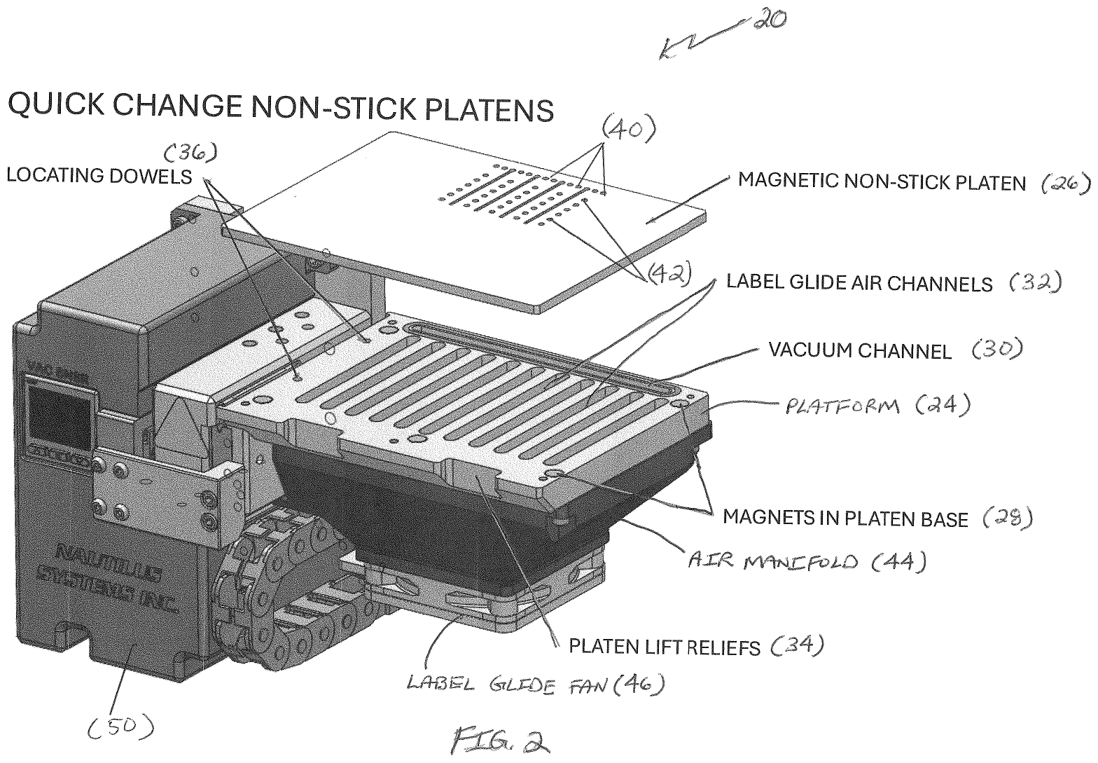

FIG. 2 is an exploded front perspective view of a portion of the system and apparatus of the present invention 10 for printing, presenting, and inspecting labels which shows one exemplary embodiment of the system and apparatus for presenting and inspecting printed labels 20 with a removable magnetic non-stick platen 26 shown removed from the platform 24. The label presenter and inspection system 20 includes a platform 24 having at least one magnet 28, at least one vacuum channel 30, and at least one air channel 32 all contained within or on the platform 24, and a removable magnetic non-stick platen 26 having at least one vacuum hole or channel 40 and at least one label glide air hole 42 contained therein where the removable magnetic platen 26 is positioned on top of the platform 24 such that the vacuum hole(s) or channel(s) 40 in the platen 26 are positioned above the vacuum channel(s) 30 in the platform 24 and the label glide air hole(s) 42 in the platen 26 are positioned above the air channel(s) 32 in the platform 24. The platform 24 may further include at least one indentation or relief area 34 to facilitate removal of the magnetic platen 26 from the platform 24 and may further include at least one locating dowel 36. The system 20 can also include an air manifold 44 positioned below the air channel(s) 32 and the vacuum channel(s) 30 located in the platform 24. A label glide fan 46 may be positioned beneath the air manifold 44. The system 20 may further include a housing 50 connected to the platform 24 and the air manifold 44.

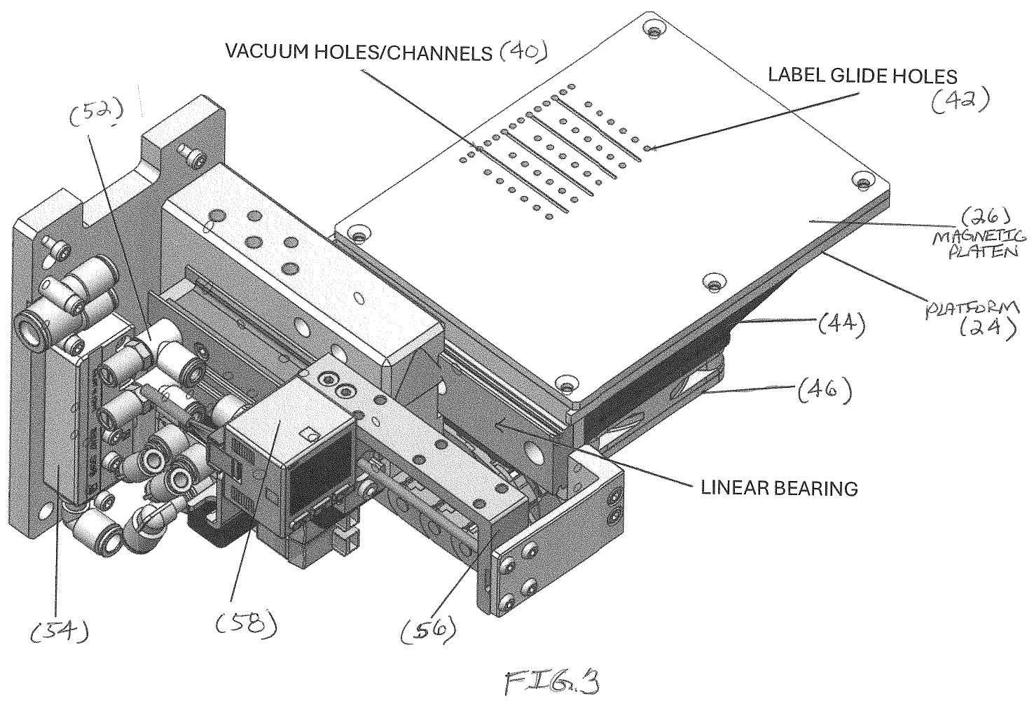

FIG. 3 is a top and side perspective view of a portion of the apparatus of the present invention which shows the system and apparatus for presenting and inspecting printed labels 20 without the housing 50 that covers a portion of the components for presenting and inspecting printed labels shown with the removable magnetic non-stick platen 26 positioned on the platform 24. The housing contains an air flow control(s) 52 for controlling air flow provided to a pneumatic shuttle 56 and a vacuum generator 54 for providing a vacuum to the vacuum channel(s) 30 contained in the platform 24. A vacuum sensor 58 may also be contained within the housing for sensing a vacuum provided to the vacuum channel(s) 30 in the platform 24. The pneumatic shuttle 56 may be located outside the housing 50 and may comprise a pneumatic or electronic mechanism or generator for shuttling/moving the platform 24 and the platen 26.

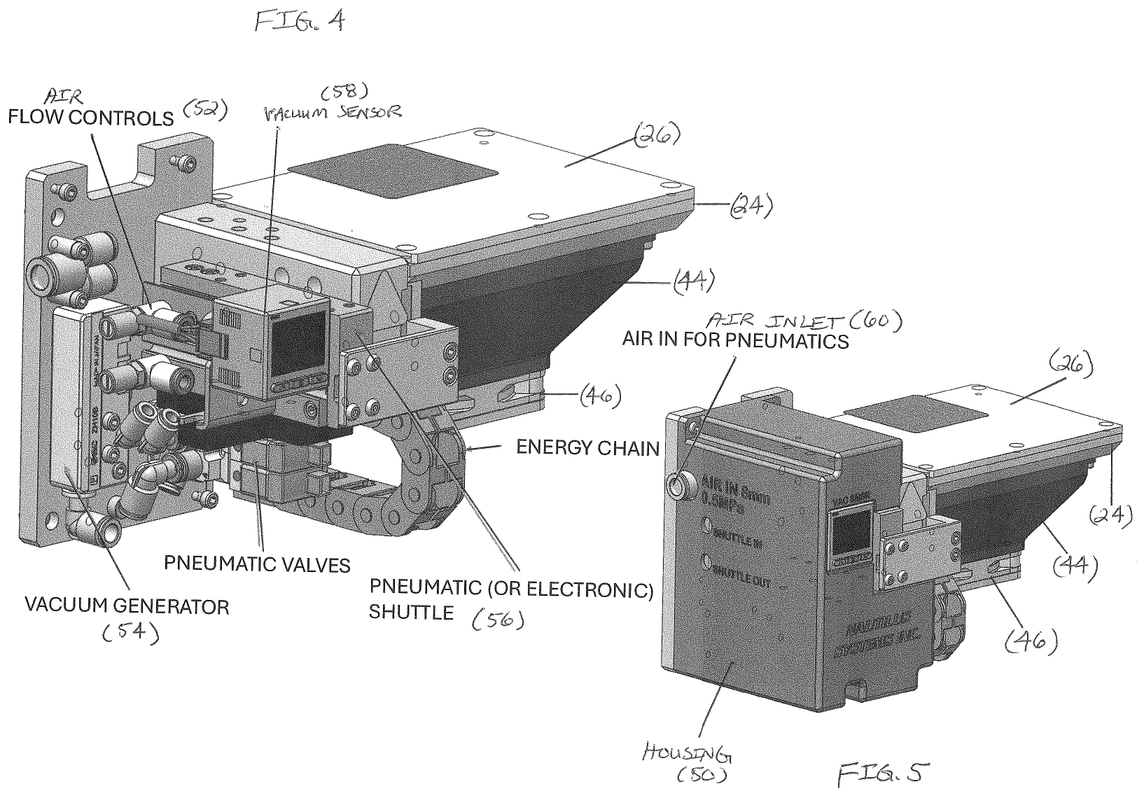

FIG. 4 is a side perspective view of a portion of the apparatus of the present invention which shows the system and apparatus for presenting and inspecting printed labels without the housing that covers a portion of the components for presenting and inspecting printed labels shown with an adhesive label positioned on the removable magnetic non-stick platen. FIG. 5 is a side perspective view of the portion of the apparatus of the present invention which shows the system and apparatus for presenting and inspecting printed labels shown in FIG. 4 with the housing that covers a portion of the components for presenting and inspecting printed labels shown with an adhesive label positioned on the removable magnetic non-stick platen. The housing 50 may include an air inlet 60 for introducing air to operate the pneumatic or electronic mechanism 56.

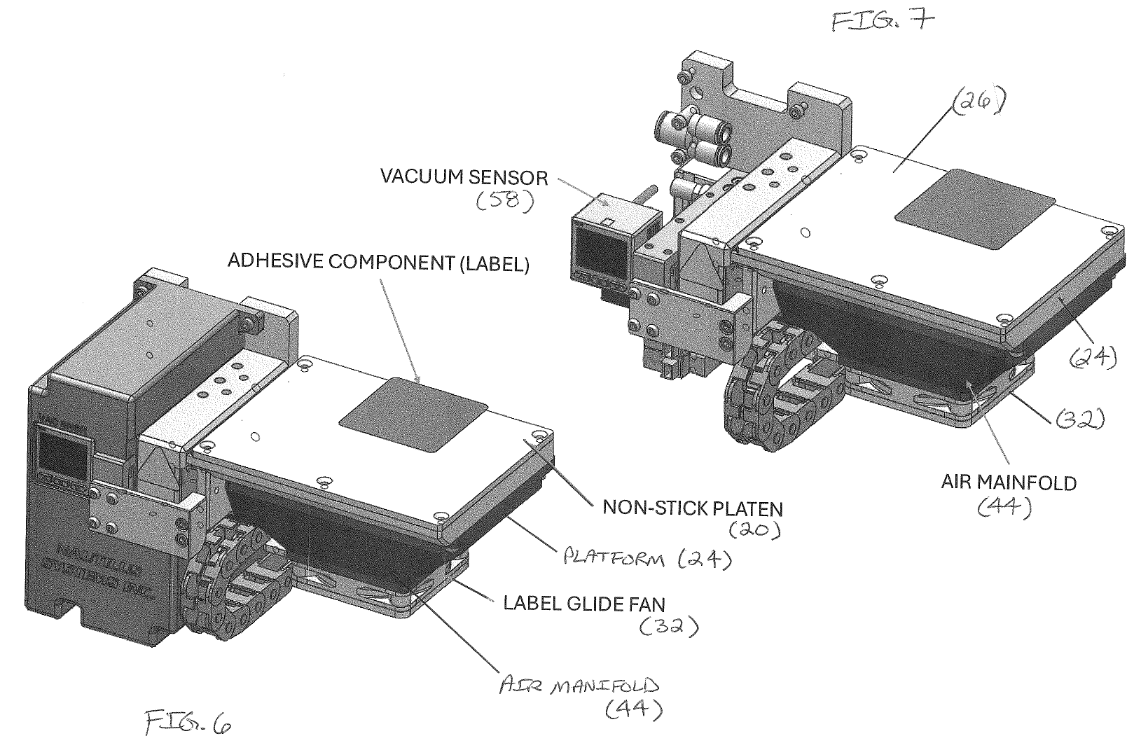

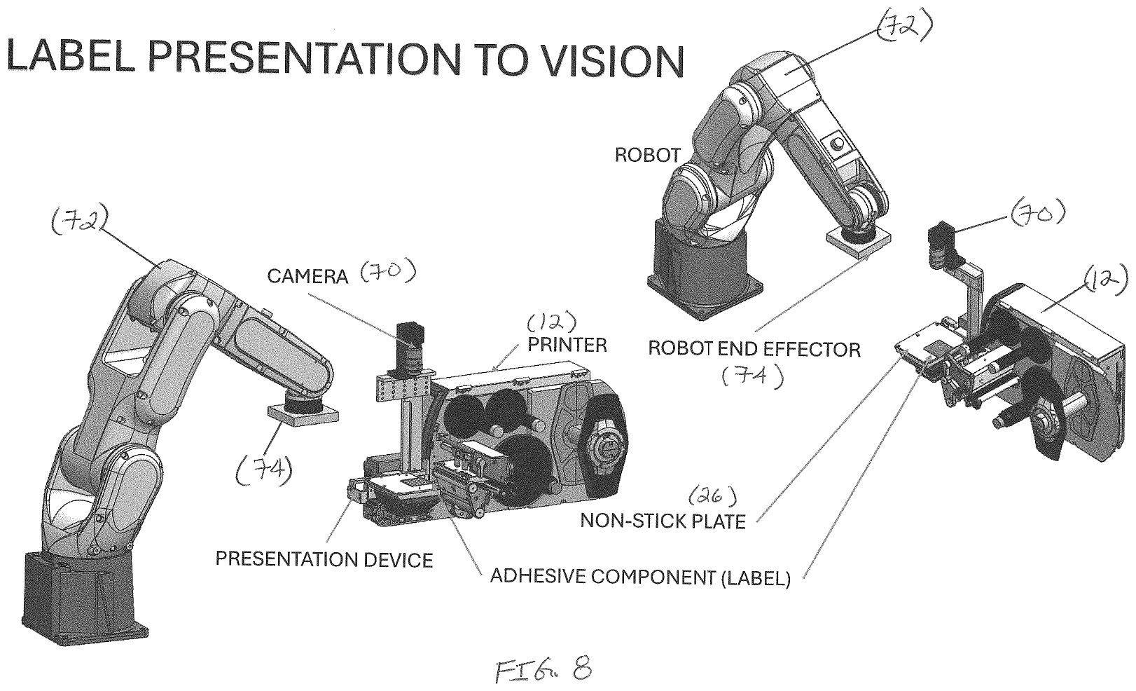

FIG. 6 is a front perspective view of the portion of the apparatus of the present invention which shows the system and apparatus for presenting and inspecting printed labels shown in FIG. 5. FIG. 7 is a front perspective view of the portion of the apparatus of the present invention which shows the system and apparatus for presenting and inspecting printed labels shown in FIG. 6 without the housing that covers a portion of the components for presenting and inspecting printed labels.

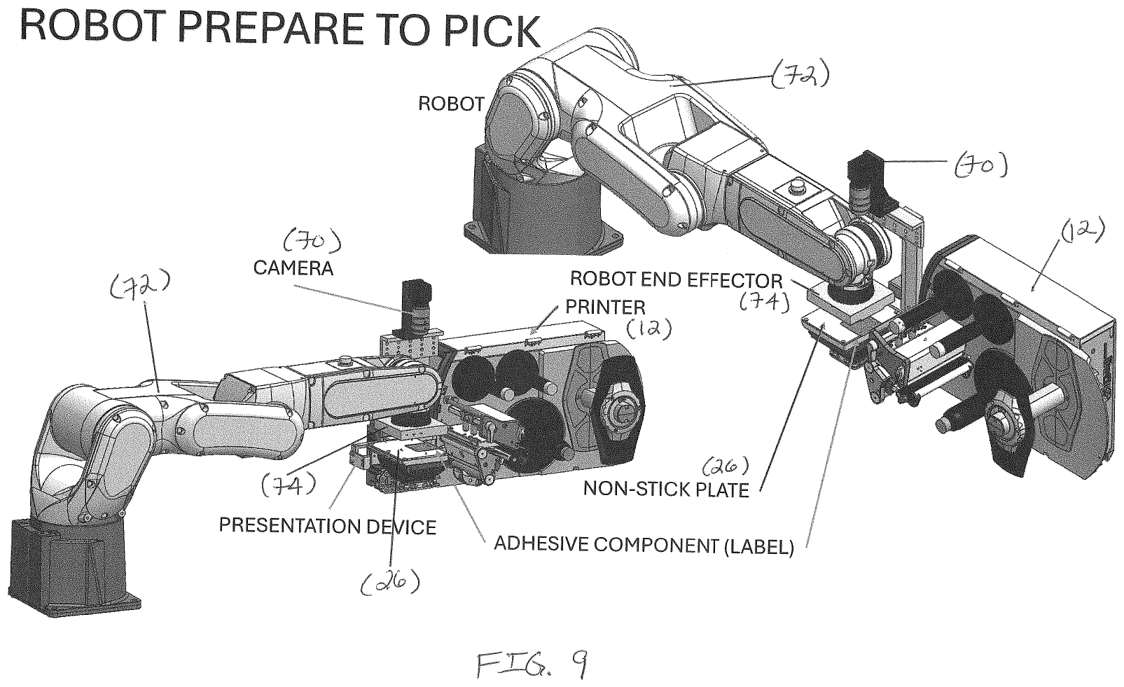

The system 20 may also include a vision system (camera) 70 that is capable of inspecting a printed adhesive label for accuracy prior to removing the label from the platen 26 and applying it to a product. FIG. 8 is a schematic showing two different perspective views of the overall system of the present invention for printing, presenting, inspecting, and removing printed labels where the system is shown in a stage where the printed label is presented and accessible for inspection by a vision system having a camera 70 and where a robotic arm 72 for removing a printed label from the removable magnetic non-stick platen 26 is in an “away” position. The robotic arm 72 has an end effector 74 which makes contact with a product label to remove the product label from the platen 26.

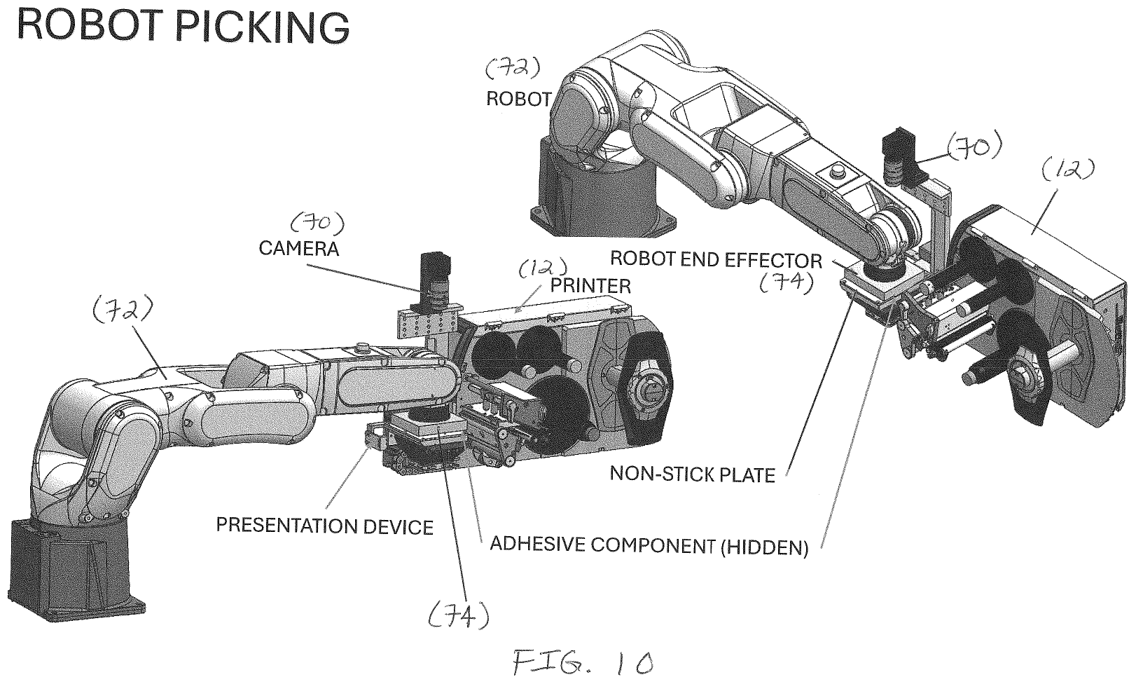

FIG. 9 is a schematic showing two different perspective views of the overall system of the present invention for printing, presenting, inspecting, and removing printed labels where the system is shown in a stage where the robotic arm 72 is moving into position to remove the printed label from the removable magnetic non-stick platen 26. FIG. 10 is a schematic showing two different perspective views of the overall system of the present invention for printing, presenting, inspecting, and removing printed labels where the system is shown in a stage where the end effector 74 of the robotic arm 72 is touching the printed label positioned on the removable magnetic non-stick platen in order to remove the printed label from the platen.

The detailed identification and description of the components of exemplary embodiments of the invention herein shows various exemplary embodiments and the best modes, known to the inventor at this time, of the invention. These exemplary embodiments and modes are described in sufficient detail to enable those skilled in the art to practice the invention and are not intended to limit the scope, applicability, or configuration of the invention in any way. Rather, the following disclosure is intended to teach both the implementation of the exemplary embodiments and modes and any equivalent modes or embodiments that are known or obvious to those reasonably skilled in the art. Additionally, all included figures are non-limiting illustrations of the exemplary embodiments and modes, which similarly avail themselves to any equivalent modes or embodiments that are known or obvious to those reasonably skilled in the art.

Other combinations and/or modifications of structures, arrangements, applications, proportions, elements, materials, or components used in the practice of the instant invention, in addition to those not specifically recited, can be varied or otherwise particularly adapted to specific environments, manufacturing specifications, design parameters, or other operating requirements without departing from the scope of the instant invention and are intended to be included in this disclosure.

Unless specifically noted, it is the Applicant's intent that the words and phrases in the specification and the claims be given the commonly accepted generic meaning or an ordinary and accustomed meaning used by those of ordinary skill in the applicable arts. In the instance where these meanings differ, the words and phrases in the specification and the claims should be given the broadest possible, generic meaning. If any other special meaning is intended for any word or phrase, the specification will clearly state and define the special meaning.

1. A label presenter and inspection system for use with a label printer which enables inspection and removal of a label comprising:
a platform having at least one magnet or fastener, at least one vacuum channel, and at least one air channel all contained within or on the platform; and
a removable magnetic or non-magnetic non-stick platen having at least one vacuum hole or channel and at least one label glide air hole contained therein wherein the removable magnetic or non-magnetic non-stick platen is positioned on top of the platform such that said at least one vacuum hole or channel in the platen is positioned above the at least one vacuum channel in the platform and said at least one label glide air hole in the platen is positioned above the at least one air channel in the platform.

2. The system of claim 1 wherein the platform further comprises at least one indentation to facilitate removal of the removable magnetic or non-magnetic non-stick platen from the platform.

3. The system of claim 1 wherein the platform further includes at least one locating dowel.

4. The system of claim 1 further comprising an air manifold positioned below the at least one air channel contained in the platform and the at least one vacuum channel contained in the platform.

5. The system of claim 4 further comprising a label glide fan positioned beneath the air manifold.

6. The system of claim 1 further comprising a housing connected to the platform and the air manifold wherein the housing contains:
at least one air flow control for controlling air flow provided to a pneumatic shuttle, when used; and
a vacuum generator for providing a vacuum to the at least one vacuum channel contained in the platform.

7. The system of claim 6 further comprising a vacuum sensor contained within the housing for sensing a vacuum provided to the at least one vacuum channel in the platform.

8. The system of claim 6 wherein the housing includes an air inlet.

9. The system of claim 1 further comprising at least one of a pneumatic or electronic mechanism for moving the platform and the removable magnetic or non-magnetic stick-free platen to another position for inspection and/or removal of a printed adhesive label positioned on top of the removable magnetic or non-magnetic non-stick platen.

10. The system of claim 9 further comprising a vision system that can inspect the printed adhesive label for accuracy prior to removing the label from the removable magnetic or non-magnetic non-stick platen and applying it to a product.

11. A label printer system and apparatus comprising:
a label printer;
a platform connected to the label printer having at least one magnet or fastener, at least one vacuum channel, and at least one air channel all contained within or on the platform; and
a removable magnetic or non-magnetic non-stick platen having at least one vacuum hole or channel and at least one label glide air hole contained therein wherein the removable magnetic or non-magnetic non-stick platen is positioned on top of the platform such that said at least one vacuum hole or channel in the platen is positioned above the at least one vacuum channel in the platform and said at least one label glide air hole in the platen is positioned above the at least one air channel in the platform.

12. The label printer system of claim 11 further comprising at least one of a pneumatic or electronic mechanism for moving the platform to another position for inspection and/or removal of a printed adhesive label positioned on top of the removable magnetic or non-magnetic non-stick platen.

13. The label printer system and apparatus of claim 12 further comprising a vision system that can inspect the printed adhesive label for accuracy while on the removable magnetic or non-magnetic non-stick platen.

14. The label printer system and apparatus of claim 13 further comprising an automated system for removing the printed adhesive label from the removable magnetic or non-magnetic non-stick platen that can apply the label to a product or place the label in a rejection collection area.

15. The label printer system and apparatus of claim 13 wherein the automated system for removing the printed adhesive label from the removable magnetic non-stick platen comprises a robotic arm with an end effector that contacts the label.

16. A method for presenting and inspecting a printed adhesive label prior to applying the label to product comprising the steps of:
providing a platform connected to a label printer wherein the platform has at least one magnet or fastener, at least one vacuum channel, and at least one air channel all contained within or on the platform;
providing a removable magnetic or non-magnetic non-stick platen having at least one vacuum hole or channel and at least one label glide air hole contained therein wherein the removable magnetic or non-magnetic non-stick platen is positioned on top of the platform such that said at least one vacuum hole or channel in the platen is positioned above the at least one vacuum channel in the platform and said at least one label glide air hole in the platen is positioned above the at least one air channel in the platform;
providing air pressure through the at least one air channel in the platform and the at least one label glide air hole in the platen to float a label across a top surface of the platen while the label is being printed; and
applying a vacuum through the at least one vacuum channel in the platform and the at least one vacuum channel in the platen to secure and hold the printed label in place on the top surface of the platen while it is inspected for accuracy.

17. The method of claim 16 further comprising the step of moving the platform to another position and inspecting the printed label for accuracy.

18. The method of claim 17 further comprising the step of removing the printed label from the top of the removable magnetic or non-magnetic non-stick platen with a robotic arm and applying it to product if the label is accurate or placing the label in a rejection collection area if the label is not accurate.
